(19) United States
(12) Patent Application Publication
(10) Pub. No.: US 2007/0056904 A1
(43) Pub. Date: Mar. 15, 2007

(54) Cleaning of filtration membranes with peroxides

(76) Inventors: Andreas Herman Hogt, Enschede (NL); Wasil Maslow, Deventer (NL); John Meuer, Deventer (NL); Andreas Petrus Van Swieten, Velp (NL)

Correspondence Address: OLIFF & BERRIDGE, PLC, P.O. BOX 19928, ALEXANDRIA, VA, 22320, US

(21) Appl. No.: 10/561,510

(22) PCT Filed: Jun. 29, 2004
(86) PCT No.: PCT/EP04/07300

§ 371 Date: Jan. 31, 2006

(30) Foreign Application Priority Data
Jul. 4, 2003 (EP) 03077118.2

(51) Int. Cl. B01D 65/02

(52) U.S. Cl. 210/636; 210/639; 210/650; 210/652

(57) ABSTRACT

The present invention relates to a process for cleaning a filtration membrane by adding one or more peroxide compounds to the influx. Preferably, one or more activators and/or reductants are added to the influx as well, in order to improve the performance of the peroxide compound. Optionally, one or more chelating agents and/or one or more surfactants can be used in said process.

The invention relates to a process for cleaning filtration membranes using peroxides.

In many chemical manufacturing processes large volumes of water are used, including raw, untreated water drawn from the immediate vicinity of the chemical plant. Such raw water contains many biologically active potential foulants as well as dissolved and suspended other foulants. As a result, it is necessary to treat such raw water streams before introduction into the plant processing systems. Furthermore, with more stringent anti-pollution standards it has also become necessary to treat most waste water or effluent streams leaving chemical plants in order to control the biological oxygen demand (BOD), colour, etc. before the water can be discharged.

Sand filtration and gravity precipitation are techniques often applied in water purification treatments for solid-liquid separation, treatments of sewage and waste water, and treatments of industrial waste water. Nowadays, different types of filtration membranes, such as precision filtration membranes or ultra-filtration membranes, are often applied for the removal of a large variety of pollutants and foulants from water streams. When said water is subjected to filtration treatment with these types of membranes, high quality treated water can be obtained.

U.S. Pat. No. 3,758,405, for example, describes a continuous method of removing and disposing of coloured particles present in aqueous effluents from Kraft pulping operations by using ultrafiltration techniques. However, a problem which arises when using filtration membranes in these types of processes is that suspended solids can clog the membranes, and a foulant layer can be built up on their surfaces. Such fouled membranes will exhibit a decreased filtration flow rate and/or an increased differential pressure between the membranes. Hence, said membranes have to be cleaned regularly.

A method for cleaning fouled membranes is for instance described in U.S. Pat. No. 4,740,308. Said method comprises the steps of removing the membrane from operation, generating singlet oxygen in situ by effecting reaction on the fouled surface of the membrane of hydrogen peroxide and an alkali metal or alkaline earth metal hypochlorite, and subsequently removing the foulant and the reaction products thereof from the membrane surface.

JP 2000117069 describes a sterilisation and washing process for a hollow fibre type ultra- or micro-filtering membrane module used in the purification of raw water. In said process, an oxidising germicide containing peracetic acid, hydrogen peroxide, and acetic acid is incorporated into back-washing water of the filter membrane module, and the back-washing is periodically performed for 0.5-2 minutes every 0.3-2 hours. Moreover, after the back-washing of the filtering membrane module, a rest period of 0.5-10 minutes is provided.

A disadvantage of the above-described membrane cleaning methods is that during operation, the membranes gradually become fouled. As a consequence, the flow rate will gradually decrease and/or the differential pressure will gradually increase until the membrane is fouled to such an extent that it needs cleaning. If one were able to slow down the fouling rate of the membranes, or even more preferably, if one were able to prevent the membranes from becoming fouled at all, the average flow rate would be higher, resulting in lower process costs and increased process capacity. Moreover, often the membranes have to be removed from operation in order to be cleaned sufficiently. Therefore, it would be a great advantage if the membranes did not have to be removed from operation that often, or even more preferably, if they did not have to be removed from operation at all in order to be cleaned.

It is therefore an object of the present invention to provide an improved cleaning process for membranes which is economically more favourable. More particularly, it is an object of the present invention to provide a preventive cleaning process for membranes, wherein fouling of the membrane during processing is reduced.

Surprisingly, we have now found that by adding a certain peroxide to the influx, the flow rate remains high, which is economically highly favourable. In addition, the membrane needs to be cleaned less frequently, and less aggressive cleaning products can be used.

In more detail, the process according to the present invention for cleaning a filtration membrane comprises dosing one or more water-soluble peroxide compounds, which are not essentially hydrogen peroxide, to the influx. By the term “which are not essentially hydrogen peroxide” is meant that the total amount of water-soluble peroxide compounds being dosed to the influx comprises at least one water-soluble peroxide compound other than hydrogen peroxide. Preferably, the total amount of water-soluble peroxide compounds being dosed to the influx comprises at least 0.1 wt %, preferably at least 0.5 wt %, more preferably at least 1 wt %, more preferably still at least 5 wt %, even more preferably at least 10 wt %, even more preferably still at least 15 wt %, and most preferably at least 25 wt % of one or more water-soluble peroxide compounds other than hydrogen peroxide. At most, the total amount of water-soluble peroxide compounds consists of 100 wt % of one or more water-soluble peroxide compounds other than hydrogen peroxide. Thus, the active substance(s) in the influx is/are the inorganic or organic peroxide(s) according to the present invention, optionally prepared in situ, instead of hydrogen peroxide, which is less active than said inorganic or organic peroxides.

It is noted that the term “influx” used throughout this document is meant to denote any aqueous stream, preferably one comprising contaminants. Preferably, the influx is an aqueous stream comprising organic compounds and/or biomass contaminants. Preferably, the process according to the present invention prevents organic contaminants from clogging the membrane. More preferably, biofouling is prevented. However, it is noted that the influx can also be an aqueous stream suitable for performing a so-called cleaning-in-place procedure, i.e. a cleaning process of a membrane wherein said membrane is temporarily removed from operation to be subjected to a different influx comprising a rinsing solution.

U.S. Pat. No. 6,325,938 also relates to a process wherein the separating membranes are cleaned during use. Here, a special solid-liquid separating membrane assembly is applied comprising at least one membrane module unit and a gas diffuser disposed below the membrane modules. Said gas diffuser generates bubbles, which upon reaching the surfaces of the membrane modules will scrub them, thus preventing solid matter from being deposited on and clogging the surfaces of the membranes. For further cleaning of the membrane surfaces, the membrane modules may be brought into contact with a cleaning solution comprising a detergent containing percarbonate and a bivalent iron salt. For this purpose, an immersion system or a liquid passing system is preferably used, in which case the immersion system involves placing the inner and outer portions of the separating membranes completely under the surface of said cleaning solution, and the liquid passing system involves passing said cleaning solution through the separating membranes in the same manner as in a regular separation operation. However, a process for cleaning a filtration membrane according to the present invention, wherein one or more water-soluble peroxide compounds are dosed to the influx, is not disclosed.

The term “peroxide compounds” as used throughout the specification is meant to denote both inorganic and organic peroxides. Peroxide compounds suitable for use in the process for cleaning filtration membranes according to the present invention include any conventional inorganic or organic peroxide compound which is sufficiently water-soluble. By the term “water-soluble” is meant that the peroxide compounds have a solubility in water of at least 0.01 ppm, but preferably of at least 0.1 ppm, more preferably of at least 1 ppm, and most preferably of at least 5 ppm.

When the peroxide compound, which is not essentially hydrogen peroxide, is dosed to the aqueous influx, the contaminants present, preferably organic compounds and/or biomass contaminations, are oxidised or decomposed due to reaction with the peroxide compound or with reactive products produced by the peroxide compound which are present in the influx, so that clogging of the membrane is prevented or, more preferably, completely inhibited. It was surprisingly found that the presence of the inorganic and/or organic peroxides according to the present invention leads to an increased oxidative activity compared to the activity of just hydrogen peroxide. It is envisaged that because of the presence of one or more carbon atoms in said inorganic or organic peroxides forming the oxidatively active substances in the influx, they have a larger affinity for the organic contaminants and/or biomass contaminants present in the influx which may be responsible for fouling the membrane. Because of their larger affinity, these types of peroxides are more efficient in adhering to said contaminants than hydrogen peroxide. As a result, these peroxides are more effective in preventing or inhibiting clogging of the membrane than hydrogen peroxide.

Preferably, one or more organic peroxide compounds are dosed to the influx. More preferably, the organic peroxide compound is selected from the group consisting of monofunctional peracids, alkali (earth) metal salts of mono-functional peracids, polyfunctional peracids, alkali (earth) metal salts of polyfunctional peracids, hydroperoxides, peresters, diacylperoxides, percarbonates, peroxydicarbonates, and alkali (earth) metal salts of percarbonates. Most preferably, a monofunctional or polyfunctional peracid is used. Preferred inorganic peroxides include alkali (earth) metal or (tetra-alkyl)-ammonium salts of peroxymono- and di-sulfates, and alkali (earth) metal or (tetra-alkyl)-ammonium salts of perborates. Preferably, the alkali metal is sodium or potassium.

Suitable monofunctional peracids which can be used include but are not limited to performic acid, peracetic acid, perpropionic acid, perbutyric acid, perisobutyric acid, perlactic acid, perpentanoic acid, perhexanoic acid, perheptanoic acid, per-2-ethylhexanoic acid, peroctanoic acid, mono-persuccinic acid, mono-perglutaric acid, and perbenzoic acid. Another example is perpyruvic acid (HOO—C(═O)—C(═O)—CH₃). Polyfunctional peracids which can be used include but are not limited to permalonic acid, persuccinic acid, perglutaric acid, pertartaric acid, permaleic acid, perfumaric acid, peritaconic acid, and percitric acid. Salts of said peracids can also be used. Examples include but are not limited to magnesium-monoperphthalic acid, magnesium-permaleic acid, and magnesium-monopercitraconic acid. In a particularly preferred embodiment, magnesium-monoperoxyphthalic acid or peracetic acid is used as the peroxide compound.

Examples of suitable hydroperoxides which can be used in the process according to the present invention are hydroperoxides of the general formula
R—OOH,
wherein R preferably is a linear or branched C₁-C₁₅ alkyl or alkyl-aryl group, preferably C₁-C₉ alkyl or alkyl-aryl group. Suitable hydroperoxides thus include but are not limited to t-butylhydroperoxide, t-amylhydroperoxide, 1,1 -dimethyl-3-hydroxybutyl hydroperoxide, cumylhydroperoxide, methyl ethyl ketone peroxide, methyl propyl ketone peroxide (any isomer), methyl butyl ketone peroxide (any isomer), acetylacetone peroxide, diacetone alcohol peroxide, hydroperoxy pyruvic acid (HO—C(═O)—C(═O)—CH₂OOH), and hydroperoxy pyruvic acid ester (RO—C(═O)—C(═O)—CH₂OOH).

Examples of suitable peresters include compounds of the general formula 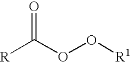
wherein R is selected from the group consisting of —CH₃; —CH(CH₃)₂; —CH(CH₂CH₃)(CH₂)₃CH₃; —C(CH₃)₂(CH₂)₂CH₃); —C(CH₃)₂(CH₂)₅CH₃; —C(CH₃)₃; —(CH₂)₈CH₃; —CH₂(CH₂)₉CH₃; —C₆H₅; and —CH₂CH(CH₃)CH₂C(CH₃)₃, and wherein R¹ is selected from the group consisting of —C(CH₃)₃; —C(CH₃)₂CH₂CH₃; C(CH₃)₂(C₆H₅); —C(CH₃)₂CH₂CH(OH)CH₃ and —C(CH₃)₂CH₂C(CH₃)₃.

A particularly preferred perester is t-butyl peracetate.

Other peroxide compounds which can be used in the process according to the present invention include. peroxides having a salt function or water-soluble substituents, like ethylene or propylene glycol esters, polyethylene or propylene glycol, polyethylene-propylene glycol copolymers, or mixtures thereof.

Percarbonates and alkali (earth) metal salts thereof can also be used as the peroxide compound in the process according to the present invention. They can be mono-, bi-, or polyfunctional. Examples of suitable percarbonates include compounds of the general formula 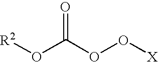
wherein R² is methyl, ethyl, linear fatty alkyl, branched fatty alkyl, and wherein X is hydrogen or an alkali (earth) metal. However, said compounds are less preferred.

It is to be understood that the word “dosing” is used to describe the step of adding the one or more peroxide compounds to the influx in order to prevent fouling of the membrane. The dosing can be done continuously, meaning that for a certain period of time the compounds are continuously added to the influx. Dosing of the peroxide compound(s) to the influx can also be done intermittently during the operation, in which case the skilled person will be able to select the optimum interval times and optimum amounts of peroxide compound(s) to be dosed by routine experimentation. A combination of these techniques is also possible. Examples of a combination of such techniques include, for instance, a process wherein the peroxide compound(s) is/are first added continuously, then the addition is stopped, and then again it/they is/are added continuously. Preferably, the peroxide(s) is/are dosed continuously or intermittently from the start of the procedure. An intermittent dosing operation is most preferred.

The peroxide compound(s) can be dosed to the influx in any conventional manner. Preferably, they are dosed to the influx in an aqueous solution.

Moreover, in a preferred embodiment of the present invention, a mixture of hydrogen peroxide and one or more organic peroxide compounds according to the invention, preferably dissolved in water, is dosed to the influx. However, organic peroxide compound(s) can also be dosed to the influx in the form of a suspension or emulsion in water. Most preferably, the peroxide compound(s) used is/are biodegradable.

It is furthermore to be understood that the phrase “dosing one or more water-soluble peroxide compounds to the influx” as used throughout the specification is meant to include the step of adding hydrogen peroxide and one or more peroxide precursors to the influx in order to prepare the one or more water-soluble peroxide compound(s) according to the invention in situ. By “peroxide precursor” is meant any compound which can be converted to a suitable water-soluble peroxide compound upon reaction with hydrogen peroxide. For example, when hydrogen peroxide and a suitable carboxylic acid or anhydride are dosed to the influx, the corresponding peracid is formed. Preferably, hydrogen peroxide and peroxide precursor are pre-mixed before dosing. A preferred example is the dosing of acetic anhydride and hydrogen peroxide to the influx under the formation of peracetic acid, catalysed by a trace of acid, or the dosing of methyl ethyl ketone and hydrogen peroxide to the influx under the formation of int. al. HOOC(CH₃)(CH₂CH₃)OOH, catalysed by a trace of acid. The acid in the mixture may also function as anti-scalant.

Typically, the total amount of peroxide compound(s) dosed to the influx is less than 1,000 mg per litre of influx. Preferably, less than 500 mg and more preferably less than 50 mg of peroxide compound(s) are dosed per litre of influx. Concentrations of peroxide compound(s) higher than 1,000 mg per litre influx are also possible, but are less preferred. Typically, more than 0.1 mg, preferably more than 1 mg, and most preferably more than 5 mg of peroxide compound(s) are dosed per litre of influx. However, if the process is a cleaning-in-place process as indicated above, preferably, the total amount of peroxide compound(s) dosed to the influx is 1-100 times the amounts just mentioned.

Preferably, the total amount of peroxide compound(s) dosed to the influx is more than 100 mg of peroxide compound(s) dosed per litre of influx. Preferably, less than 2,000 mg, more preferably less than 1,500 mg of peroxide compound(s) are dosed to the influx.

Preferably, one or more activators are dosed to the influx in order to improve the performance of the peroxide compound. The activator preferably is a metal salt wherein the metal ion has a suitable oxidation potential versus the peroxide compound. In a preferred embodiment of the present invention, the metal is selected from the group consisting of Fe, Mn, Cu, Ni, Cr, V, Ce, Mo, and Co. In another preferred embodiment, an amino group-containing compound is employed. Suitable amine compounds for use in the process according to the present invention include dimethyl aniline, diethyl aniline, dimethyl toluidine, polymeric aromatic amines, quaternary amines, nitroxides, and amine salts. In yet another preferred embodiment of the present invention, the activating metal ion is complexed with or incorporated into the peroxide compound.

Normally, the total amount of activator(s) dosed to the influx is less than 1,000 mol % per litre of influx, based on the total amount of peroxide compound present per litre of influx. Preferably, less than 300 mol %, and more preferably less than 150 mol % is dosed per litre of influx, based on the total amount of moles of peroxide compound present per litre of influx. Normally, more than 0.1 mol %, preferably more than 1 mol %, and most preferably more than 10 mol % of activator(s) is used per litre of influx, based on the total amount of moles of peroxide compound present per litre of influx.

In the process according to the present invention, reductants can be used to influence the oxidation potential of the metal ions. Preferred reductants include but are not limited to ascorbic acid, citric acid, tartaric acid, oxalic acid, sodium formaldehyde sulfoxylate, and (bi)sulfite salts. Normally, the total amount of reductant(s) dosed to the influx is less than 1,000 mol % per litre of influx, based on the total amount of moles of peroxide compound present per litre of influx.

Preferably, less than 300 mol %, and more preferably less than 150 mol % is dosed per liter of influx, based on the total amount of moles of peroxide compound present per litre of influx. Normally, more than 0.1 mol %, preferably more than 1 mol %, and most preferably more than 10 mol % of reductant(s) is used per litre of influx, based on the total amount of moles of peroxide compound present per litre of influx.

When using reductant(s), the amount of activator(s) can be reduced about ten-fold, most preferably in the range of 0-20 mol %. If the water in the influx contains a sufficient amount of metal salt suitable as activator, such as an iron source, the separate addition of one or more activators to the influx may not be necessary at all.

Preferably, one or more reductants are dosed to the influx in order to improve the performance of the peroxide compound. The reductant preferably is a compound that reduces the activator to a suitable oxidation potential versus the peroxide compound. In a preferred embodiment of the present invention, the reductant is selected from the group consisting of (bi)sulfites, sulfides, phosphites, oxalic acid, ascorbic acid, isoascorbic acid, sodium formaldehyde sulfoxylate. Most preferably, ascorbic acid is used as the reductant.

Irrespective of the dosing procedure for the peroxide compound(s), the activator(s) and/or reductant(s) can be dosed continuously, intermittently, or by a combination of these techniques. An intermittent dosing procedure is again preferred. In the intermittent dosing procedure, it is possible to add the peroxide compound(s) and the activator(s) and/or the reductant(s) at the same time. However, it is preferred to add them to the influx successively at certain intervals or at different spots in the influx supply. Between the dosing intervals there may also be a certain time with no dosage at all. In a particularly preferred embodiment of the present invention, one or more activators and/or one or more reductants are dosed continuously to the influx for a certain period of time, and after the addition has stopped, one or more peroxide compounds are dosed continuously to the influx for a certain period of time, and this procedure is then repeated.

The term filtration membrane as used throughout this specification can apply to any conventional polymeric and/or ceramic filtration membrane. In general, these membranes are characterised by their MWCO (molecular weight cut-off) and/or their retention values for inorganic salts and/or small organic molecules. The membranes suitable for use in the process according to the present invention include reverse osmosis membranes (pores smaller than 0.11 nm), nanofiltration membranes (0.8 nm up to 9 nm pores), ultrafiltration membranes (3 nm up to 100 nm pores), microfiltration membranes (50 nm up to 3 μm pores), and particle-filtration membranes (2 μm up to 2 mm pores). The person skilled in the art can select the proper membrane on the basis of common general knowledge. Particularly preferred membranes are reverse osmosis and nanofiltration membranes. Preferably, the process according to the invention is not used for cleaning a contaminated semipermeable membrane which is employed in a pervaporation or vapour permeation procedure wherein water is transported through said semipermeable membrane.

In the process according to the present invention it is also possible to add one or more chelating compounds, optionally in combination with one or more activators. Suitable chelating agents include but are not limited to carboxy-methylene amino derivatives like NTA (nitrilotriacetic acid), EDTA (ethylene diamine tetraacetic acid), DTPA (diethylene triamine pentaacetic acid), methylene phosphonated amine derivatives like ATMP (amino tri(methylene phosphonic acid)), EDTMP (ethylene diamine-tetra-methylene phosphonic acid), citric acid, gluconate, glucoheptanoate, lactate, and sorbitol.

It is also possible to add one or more surfactants, again optionally in combination with one or more activators. Suitable surfactants include conventional cationic, anionic, and non-ionic surfactants. For example, alkali (earth) metal salts of fatty acids, mono-, bi-, and poly-quaternary ammonium salts, and fatty amine derivatives can be applied.

Again, the chelating compound(s) and/or surfactant(s) can be dosed to the influx continuously, intermittently, or by a combination of these techniques, irrespective of the dosing procedure for the one or more peroxide compound(s) and/or the one or more activators. Preferably, the chelating compound(s) and/or surfactant(s) are intermittently dosed to the influx. The chelating compound(s) and/or surfactant(s) are used in conventional amounts. Other additives which can be dosed to the influx include conventional anti-scaling agents.

In a particularly preferred embodiment according to the present invention, in addition to the one or more peroxide compounds, one or more activators, one or more reductants, one or more chelating compounds, and/or one or more detergents are added to the influx. If desired, one or more conventional pH regulators may be added to the influx as well, provided they do not negatively affect the cleaning process according to the present invention. Preferably, the additives are present in the formation of the peroxide, the activator(s), the reductant(s), or in the pre-mixture of hydrogen peroxide and peroxide precursor.

The present invention is elucidated by means of the following non-limiting Examples.

### EXAMPLE 1

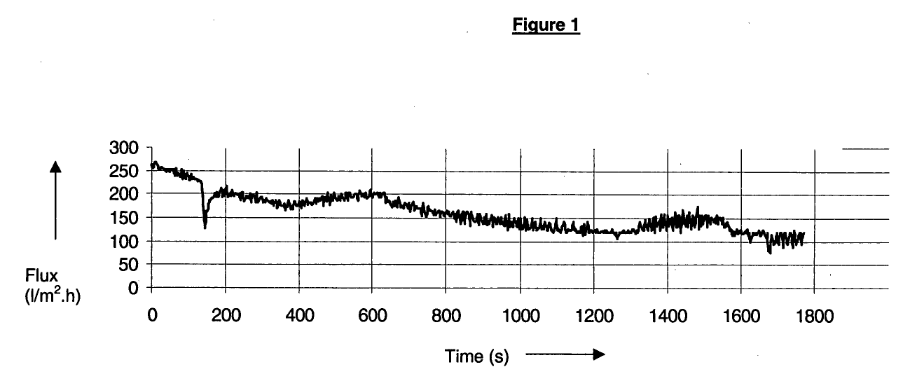

An influx comprising organic contaminants and biomass contaminants was subjected to a filtration procedure using a tubular ultrafiltration membrane of the type UFC M5 ID 0.8 mm, the membrane material being polyvinyl/pyrrolidone. A constant transmembrane pressure of 5.0 bar was applied. At the start of every experiment, the clean water flux (CWF) was determined using demineralised water. The influx was filtrated, and the decrease in flux (=flow rate) was measured (see FIG. 1).

Starting from t=0 s, 1 mg/l of Trigonox® 44B ex Akzo Nobel was continuously added to the influx. The flux was measured to decrease from 250 l/m².h to 170 l/m².h from t=0 s to t=400 s. After 400 s, 1 mol % of Fe(SO₄)₂, based on the amount of peroxide compound present per litre in the influx, was added for a period of 250 s (from t=400 s to t=650 s). From FIG. 1, it was observed that the flux increased from about 170 l/m².h to 200 l/m².h. The flux was observed to decrease from 200 l/m².h to 125 l/m².h over t=650 s to t=1,350 s. When again 1 mol % of Fe(SO₄)₂, based on the amount of peroxide compound, was added for a period of 250 s (from t=1,350 s to t=1,600 s), an increase in flux of 125 l/m².h to 150 l/m².h was observed.

### EXAMPLE 2

An influx comprising organic contaminants and biomass contaminants was subjected to a cross-flow filtration procedure using a thin film composite capillary nanofiltration membrane of the type NF50 M10, the membrane material being polyamide/polyether sulphone. A constant transmembrane pressure of 3.0 bar was applied and the cross-flow velocity along the membrane was 0.4 m/s (laminar flow). At the start of every experiment, the clean water flux (CWF) was determined using demineralised water. Subsequently, the influx was filtrated for 30 min, and the decrease in flux (=flow rate) was determined. In order to prevent the membrane from fouling, the following peroxide compounds were continuously dosed to said influx:
1 mg per litre of influx of methyl ethyl ketone peroxide (MEKP);
1 mg per litre of influx of Trigonox® 44B ex Akzo Nobel N. V.; and
a formulation comprising
   water: 17.2±0.1% m/m
   H₂SO₄: 1.0±0.1% m/m
   acetic acid: 43.8±0.2% m/m
   peracetic acid: 33.6±0.2% m/m
   H₂O₂: 4.8±0.1% m/m,
in such an amount that 1 mg or 0.1 mg of peracetic acid was dosed to the influx.

Again, the decrease in flux was determined.

Furthermore, 1 mol %, based on the total amount of peroxide compound(s), of activator was continuously dosed to the influx. Said activator was Fe(II) sulfate.

The results of these experiments are shown in Table 1.

TABLE 1

| | | Amount of | Amount of | |
|---|---|---|---|---|
| | | peroxide | activator | % decrease |
| | Additive(s) dosed | (mg per litre | (mol % based | in flux after |
| Entry | to influx | of influx) | on peroxide) | 1500 s |
| (1) | — | — | — | 39.6 |
| (2) | MEKP and Fe(SO₄) | 1 | 1 | 32.5 |
| (3) | Trigonox ® 44B | 1 | — | 33.7 |
| (4) | Trigonox ® 44B, | 1 | 1 | 32.4 |
| | Fe(SO₄) | | | |
| (5) | Peracetic acid, | 1 | 1 | 31.6 |
| | Fe(SO₄) | | | |
| (6) | Peracetic acid | 0.1 | — | 35.9 |
| (7) | Peracetic acid, | 0.1 | 1 | 34.1 |
| | Fe(SO₄) | | | |

It was found that when using 1 mol % of Fe(SO₄) as activator in addition to 1 mg of methyl ethyl ketone peroxide, 1 mg of Trigonox® 44B, or 1 mg of peracetic acid formulation per litre of influx, the decrease in the flux (=flow rate) is significantly lower than when the peroxide compound only is used.

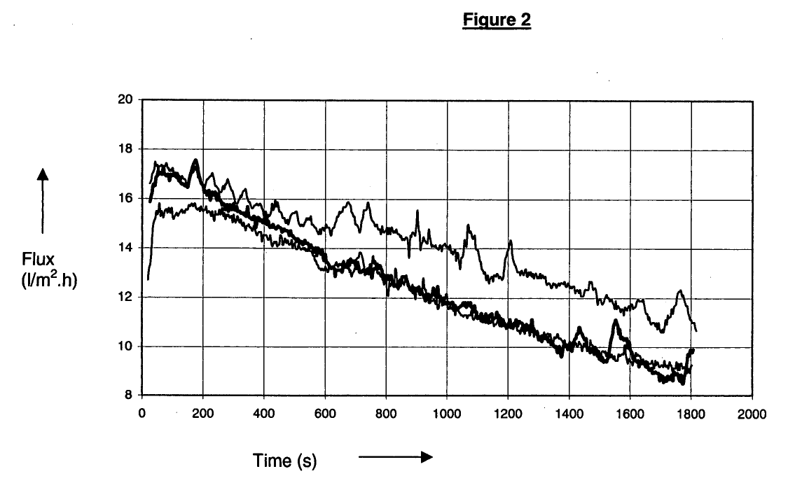

FIG. 2 shows the decrease in flux in time for the above-described experiment using said peracetic acid-comprising formulation, optionally in combination with a Fe-activator, where:

[symbol] shows the decrease in flux of the blank procedure, i.e. without the addition of a peroxide compound to the influx;

[symbol] shows the decrease in flux when an amount of the above-mentioned peracetic acid formulation is continuously dosed to the influx, with 1 mg of peracetic acid being introduced per litre of influx; and

[symbol] shows the decrease in flux when in addition to the 1 mg/l of peracetic acid, 1 mol % of Fe(SO₄)₂ is continuously dosed to the influx.

As can be observed from FIG. 2, continuously dosing the peracetic acid formulation to the influx has an advantageous effect on the flux during the first 400 seconds of the procedure. However, when the Fe-activator is continuously dosed to the influx in addition to the peracetic acid formulation, the flux remains significantly higher during the whole procedure.

1. Process for cleaning a filtration membrane by dosing one or more water-soluble peroxide compounds, which are not essentially hydrogen peroxide, to the influx.

2. Process for cleaning a filtration membrane according to claim 1 wherein furthermore one or more activators and/or one or more reductants are dosed to the influx.

3. Process for cleaning a filtration membrane according to claim 2 wherein the activator comprises a Fe-salt, a Mn-salt, a Cu-salt, a Ni-salt, a Co-salt, or an amine compound, and preferably, said activator comprises a Fe-salt.

4. Process for cleaning a filtration membrane according to claim 2 wherein the reductant is selected from the group consisting of oxalic acid, a (bi)sulfite salt, ascorbic acid, isoascorbic acid, and sodium formaldehyde sulfoxylate.

5. Process for cleaning a filtration membrane according to claim 1 wherein the peroxide compound is selected from the group consisting of monofunctional peracids, alkali (earth) metal salts of monofunctional peracids, polyfunctional peracids, alkali (earth) metal salts of polyfunctional peracids, organic hydroperoxides, peresters, percarbonates, alkali (earth) metal salts of percarbonates, alkali (earth) metal or ammonium salts of persulfates, and alkali (earth) metal or ammonium salts of perborates.

6. Process for cleaning a filtration membrane according to claim 5 wherein the peroxide compound is selected from the group consisting of peracetic acid, perpropionic acid, monopersuccinic acid, monoperglutaric acid, acetylacetone peroxide, and magnesium monoperoxyphthalic acid.

7. Process for cleaning a filtration membrane according to claim 1 wherein one or more chelating compounds are added to the influx.

8. Process for cleaning a filtration membrane according to claim 1 wherein one or more surfactants are added to the influx.

9. Process for cleaning a filtration membrane according to claim 1 wherein one or more activators, one or more reductants, one or more chelating compounds, and one or more surfactants are added to the influx.

10. Process for cleaning a filtration membrane according to claim 2 wherein the activator and/or reductant is intermittently added to the influx.

11. Process for cleaning a filtration membrane according to claim 1 wherein the peroxide compound is intermittently added to the influx.

12. Process for cleaning a filtration membrane according to claim 1 wherein the membrane is selected from the group consisting of a reverse osmosis membrane, a nanofiltration membrane, an ultrafiltration membrane, a microfiltration membrane, and a particle filtration membrane.
